(19) United States
(12) Patent Application Publication
(10) Pub. No.: US 2010/0324930 A1
(43) Pub. Date: Dec. 23, 2010

(54) IMAGING MANAGEMENT APPARATUS FOR MEDICAL USE

(75) Inventors: Yutaka Ueda, Tokyo (JP); Takao Shiibashi, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: KONICA MINOLTA MEDICAL & GRAPHIC, INC, Hino-shi, Tokyo (JP)

(21) Appl. No.: 12/867,810

(22) PCT Filed: Feb. 16, 2009
(86) PCT No.: PCT/JP2009/052466

§ 371 Date: Aug. 16, 2010

(30) Foreign Application Priority Data
Feb. 19, 2008 (JP) 2008-037560

(51) Int. Cl. G06Q 50/00; G06Q 10/00

(52) U.S. Cl. 705/2

(57) ABSTRACT

Provided is an image management apparatus for medical use which allows a small-scale medical treatment facility such as a practitioner to easily and efficiently associate image data generated by an image generation apparatus with patient information. The image management apparatus for medical use is equipped with a storage section (32) which is connected to an image generation apparatus (2) so that data can be communicated therebetween and stores patient information relating to patients, a patient selecting means for selecting a patient to be examined from among the patients stored in the storage section (32), a patient specifying means for specifying the patient selected by the patient selecting means as a patient to be associated with image data, and a controlling section (31) which associates, when the patient is specified by the patient specifying means, the image data transmitted from the image generation apparatus (2) whith the patient information relating to the specified patient, and automatically associates the image data with the patient information according to a predetermined allocation rule when no patient is specified by the patient specifying means.

### TECHNICAL FIELD

The present invention is related to an image management apparatus for medical use, in particular, to an image management apparatus for medical use used in a small medical facility.

### BACKGROUND ART

Conventionally, there is known a diagnostic system in which a technician carries out image taking of a patient visiting a medical facility who is a target for examination by using an image generation apparatus such as an image taking device of CR (Computed Radiography), an image taking device of FPD (Flat Panel Detector) and the like and in which image processing such as a gradation process is carried out so that the obtained image can be provided for diagnosis and outputting the image after the image processing is carried out to be provided for reading by a doctor.

In such diagnostic system, diagnosis is proceeded by a plurality of persons in charge taking roles such as a role (reception) to accept a patient who visited the hospital, a role (technician) to actually carry out an image taking of the patient in an image taking room and to generate an image data, a role (a technician who is appointed among general technicians or the like) to determine the tone and the like of the obtained image whether the obtained image can be provided for diagnosis or not, and in certain instances, to correct the contrast and density of the image, a role (doctor) to read to determine (diagnose) whether there is a disease or not based on the image, and the like.

In a large medical facility (hereinafter, called a large facility) in which usage of the above conventional diagnostic system is assumed, in many cases, places where the above mentioned each role is carried out is distanced from each other within the large hospital such that the reception is on first floor, the department of radiology is on basement floor and the like. Further, there are plurality of image generation apparatuses and there are plurality of technicians and the like who operate the image generation apparatuses. Furthermore, consoles for operating the image generation apparatuses, viewers for the doctors to confirm the image data and the like are individually provided so as to take each role. It is normal that image taking of a plurality of patients are carried out by a plurality of technicians using a plurality of image taking devices at a same time in the department of radiology, and a plurality of patients are always being held at each process.

Therefore, there is a possibility that the image data generated in the image generation apparatuses and the patients are mistakenly associated. Consequently, in order to prevent mixing-up of image data and each patient, there is suggested a system in which each of the apparatuses are linked via a network and in which ID is issued in each of the apparatuses for each operation in each process so as to associate the result of the operation process carried out in each of the apparatuses to each other (for example, see patent document 1).

Further, association of ID to be attached to each operation in each process is carried out via a network of HIS (Hospital Information System) or RIS (Radiology Information System), for example (for example, see patent document 2 and patent document 3).

However, according to a study carried out by the inventors of the present application and the like, in a relatively small medical facility (hereinafter, called a small facility) such as a private practice and a clinic, in many cases, one doctor carries out diagnosis of patients and the number of image generation apparatuses set is small. There are many situations where an assistant carries out the positioning of the patient and the doctor controls the radiation exposure switch upon receiving a cue indicating that the positioning is completed from the assistant and there are many situations where the doctor himself/herself carries out the entire operation including the positioning of the patient.

Further, for example, in case of a large facility, image taking is carried out to a plurality of patients at the same time in many cases and it is assumed that there is a plurality of information system. However, in case of a small facility, the number of patients to whom the image taking is to be carried out is not as large as that of the large facility and the possibility of the plurality of information system tangling up is also small.

Under such circumstances, it is very scarce that the taken images get mixed up with other patient. Nevertheless, if the system similar to that of large facility is used, the procedure becomes rather complicated because generating operation of image taking order information including inputting of patient name and the like is necessary and the diagnosis is inefficient.

Moreover, in order to generate the image taking order information such as patient information, image taking condition information and the like of the patient in advance and in order to associate the image taking order information with the taken image, a system for connecting each of the apparatuses with a network corresponding to a backbone system such as RIS/HIS is needed. However, it is very expensive to establish such system and also, a device to coordinate the backbone system with the data is necessary (for example, see patent document 4 and patent document 5), and there is a problem that this is a burden to a small facility. Further, even if the number of apparatuses is reduced while maintaining the above described structure concept of large facility, it is difficult of improve diagnosis efficiency and it cannot be said that the system is suited for a small facility. Patent Document 1: U.S. Pat. No. 5,334,851 Patent Document 2: JP 2002-159476 Patent Document 3: JP 2002-311524 Patent Document 4: JP 2006-92261 Patent Document 5: JP 2003-248723

### DISCLOSURE OF THE INVENTION

Problem to be Solved by the Invention

In view of the above problem, an object of the present invention is to provide an image management apparatus for medical use which can easily and efficiently carry out association of image data which is generated in an image generation apparatus and patient information in a small medical facility such as a private practice.

### MEANS FOR SOLVING THE PROBLEM

In order to solve the above problem, the present invention is connected to an image generation apparatus for generating image data relating to a patient so as to carry out sending and receiving of data and the present invention includes a patient information storage section for storing patient information of patients who are to be examined, a patient selection section for selecting a patient who is to be a target for examination among the patients stored in the patient information storage section, a patient specification section for specifying the patient selected by the patient selection section as a patient to whom the image data is to be associated with and a control unit for associating the image data transmitted from the image generation apparatus with patient information of the patient who is specified when the patient is specified by the patient specification section, and for automatically associating the image data with patient information of a patient according to an predetermined allocation rule when the patient is not specified by the patient specification section.

Further, preferably, according to the allocation rule of associating the image data with the patient information of the patient selected by the patient selection section when receiving the image data, the control unit associates the image data with the patient information of the patient.

Further, preferably, according to the allocation rule of associating the image data with patient information according to a type of the image generation apparatus which generated the image data, the control unit associates the image data with the patient information of the patient.

Further, preferably, according to the allocation rule of associating the image data with patient information of a patient who is specified in advance, the control unit associates the image data with the patient information of the patient.

Further, preferably, further includes a display section, and when an association of the image data and the patient information is carried out automatically according to the allocation rule, the control unit makes the display section display an indication notifying that the association is carried out according to the allocation rule.

### EFFECT OF THE INVENTION

According to the present invention, association between image data which is generated in an image generation apparatus and patient information can be carried out efficiently without causing trouble to a doctor and the like even in a small medical facility such as a private practice or the like in which a backbone system such as RIS and the like is not introduced.

Moreover, in a case when carrying out association between image data and patient information according to an allocation rule of associating the image data to the patient information of the patient who is selected by a patient selection device in time of receiving the image data, the patient information of the patient who should be associated with the image data can be appropriately associated with the image data.

Further, in a case when carrying out association between image data and patient information according to an allocation rule of associating the image data with the patient information according to a type of the image generation apparatus by which the image data is generated, the patient information of the patient who should be associated with the image data and the image data can be appropriately associated when the patients to whom image taking may be carried out is identified to some extent for each image generation apparatus.

Furthermore, in a case when carrying out association between image data and patient information according to an allocation rule of associating the image data to the patient information of a specific patient who is specified in advance, the image for reading and diagnosis can be made to be in a state where they can be opened even when the image for reading and diagnosis cannot be opened unless the image is association with patient information.

Moreover, when the association between image data and patient information is carried out automatically according to an allocation rule and not according to specifying by the patient specification device, a user such as a doctor or the like can be notified because an indication notifying that the association was carried out automatically according to an allocation rule is displayed in the display section. Thereby, whether the association between the image data and the patient information is carried out correctly or not can be reviewed when the doctor carries out reading and diagnosis, and mixing-up of image data and patient information can be prevented before it occurs.

### BRIEF DESCRIPTION OF THE DRAWINGS

FIG. 1 This is a diagram showing an example of entire structure of a small-scale diagnosis system of the embodiment.

FIG. 2 This is an explanatory diagram schematically showing a flow of image data between main apparatuses which structure the small-scale diagnosis system shown in FIG. 1.

FIG. 3 This is a diagram showing an example of arrangement of each apparatus in a medical facility in a case where the small-scale diagnosis system shown in FIG. 1 is applied.

FIG. 4 This is a main part block diagram showing a functional structure of an image management apparatus for medical use 3 which is applied in the small-scale diagnosis system shown in FIG. 1.

FIG. 5 This is a diagram showing an example of a patient information list screen which is displayed in a display section of FIG. 4.

FIG. 6 This is a diagram showing an example of a patient display screen which is displayed in the display section of FIG. 4.

FIG. 7 This is a diagram showing an example of the patient display screen of FIG. 6.

FIG. 8 This is a flowchart showing a patient information association process which is executed by a control section of FIG. 4.

FIG. 9 This is a flowchart showing a content of process A within the patient information association process of FIG. 8.

FIG. 10 This is a flowchart showing a content of process C within the patient information association process of FIG. 8.

FIG. 11 This is a flowchart showing a content of process E within the patient information association process of FIG. 8.

FIG. 12 This is a flowchart showing a content of process G within the patient information association process of FIG. 8.

FIG. 13 This is a flowchart showing a content of process I within the patient information association process of FIG. 8.

FIG. 14 This is a flowchart showing a process in a case where association is carried out automatically according to an allocation rule for an undetermined image.

### BEST MODE FOR CARRYING OUT THE INVENTION

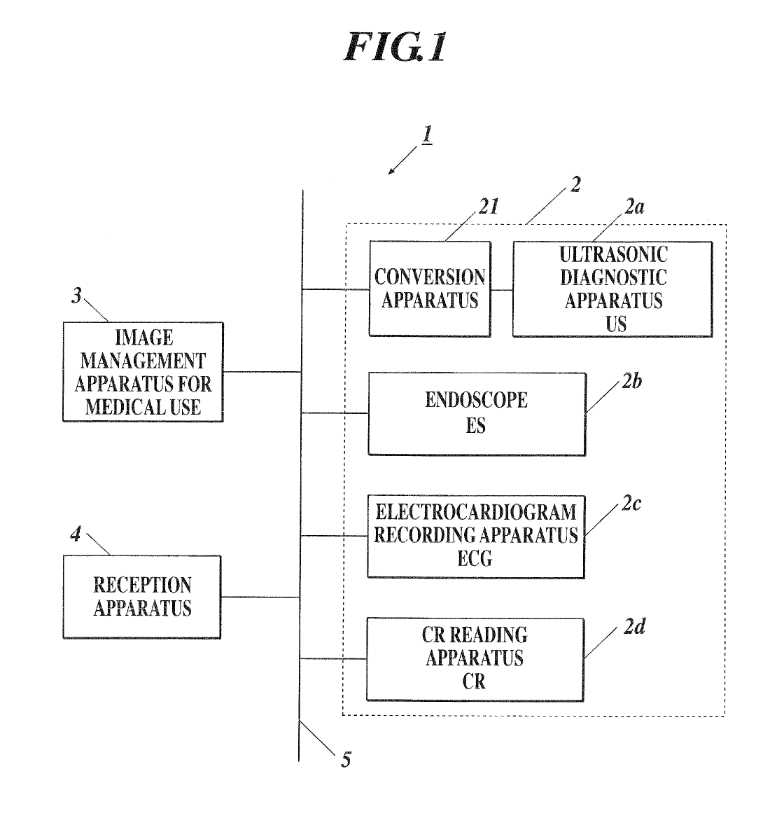

Hereinafter, a small-scale diagnosis system 1 in which an embodiment of an image management apparatus for medical use according to the present invention is applied will be described with reference to FIGS. 1 to 14. Here, the present invention is not limited to the examples shown in the drawings.

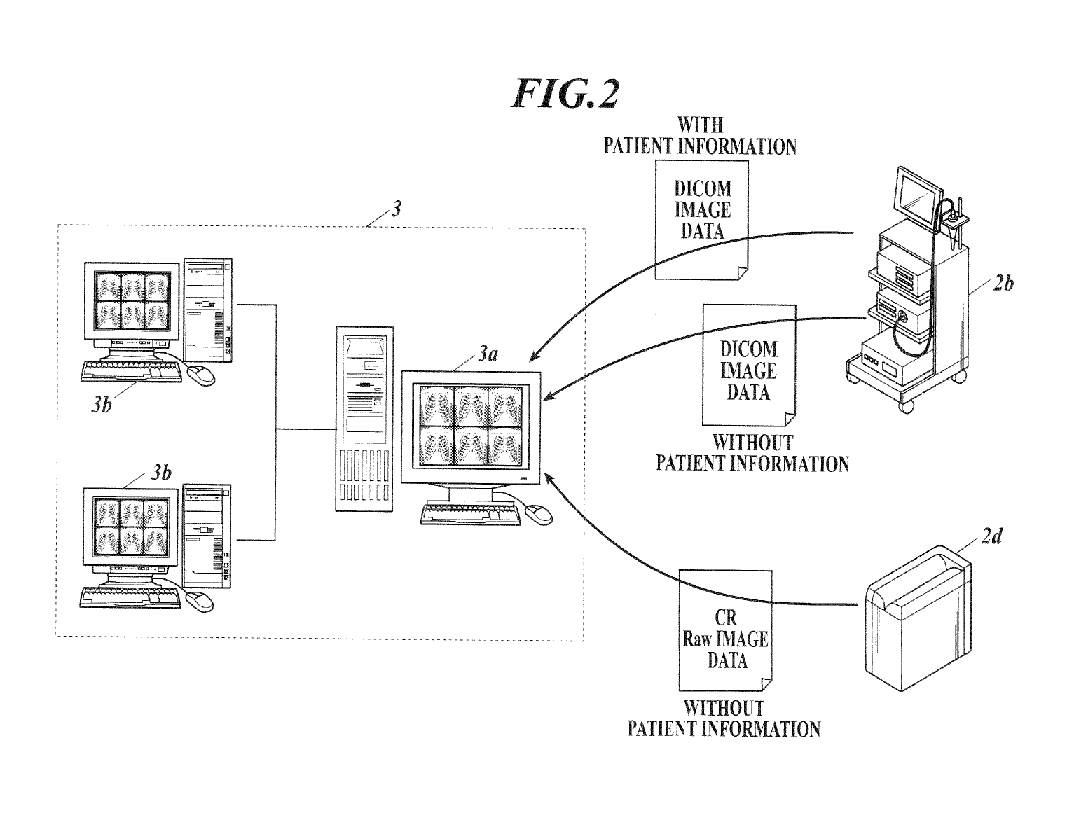

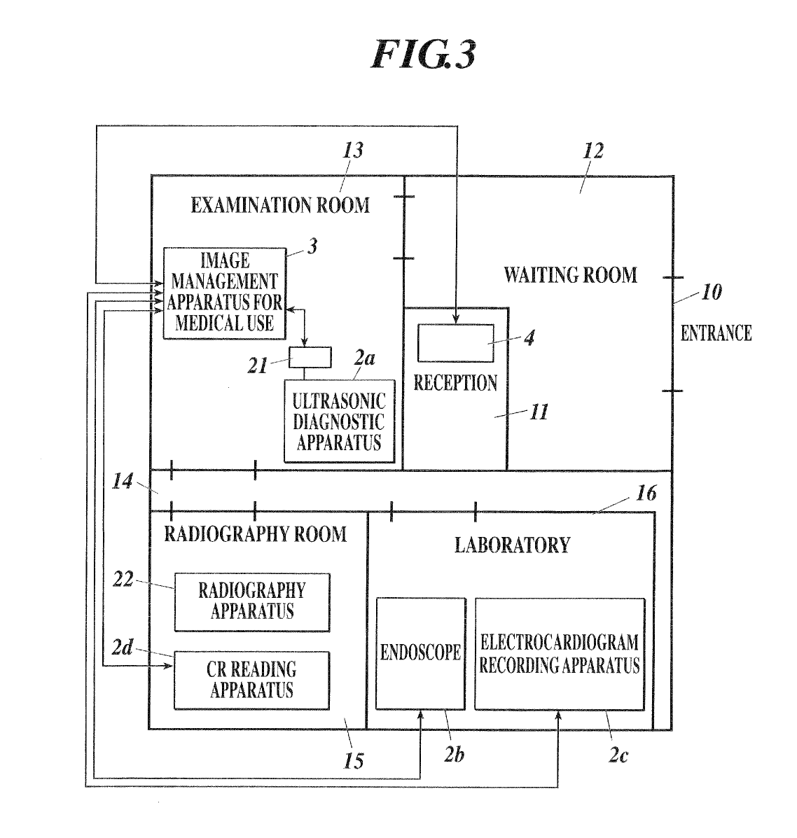

FIG. 1 is a block diagram showing a system structure of the small-scale diagnosis system 1, FIG. 2 is a diagram schematically showing a flow of image data between main apparatuses in the embodiment and FIG. 3 shows an example of arrangement of each apparatus in a medical facility in a case where the small-scale diagnosis system 1 is applied.

The small-scale diagnosis system 1 is a system which is to be applied in a relatively small medical facilities such as private practices, clinics and the like. As shown in FIG. 1, the small-scale diagnosis system 1 includes an ultrasonic diagnostic apparatus (US: ultrasonography) 2a, an endoscope (ES: endoscope) 2b, an electrocardiogram recording apparatus (ECG: Electrocardiogram) 2c and a CR reading apparatus 2d which are image generation apparatuses 2, an image management apparatus for medical use 3 and a reception apparatus 4. The image generation apparatuses 2, the image management apparatus for medical use 3 and the reception apparatus 4 are connected to a communication network (hereinafter, merely called “network”) 5 such as a LAN (Local Area Network) or the like via a switching hub or the like which is not shown. It is preferred that the image management apparatus for medical use 3 is a WS (work station) provided in an examination room which is the place where the doctor always stays at. Here, the structure may be that the WS which operates as the image management apparatus for medical use 3 controls activation and process condition and the like of each of the image generation apparatuses 2.

As for the communication method in the medical facility, DICOM (Digital Image and Communications in Medicine) format is generally used, and DICOM MWM (Modality Worklist Management) or DICOM MPPS (Modality Performed Procedure Step) is used for communication between each of the apparatuses which are connected by LAN. Here, the communication method which can be applied to the embodiment is not limited to the above. Further, an apparatus which does not correspond to DICOM format may be included in the apparatuses connected by LAN. In the embodiment, the CR reading apparatus 2d is an apparatus which does not correspond to DICOM format.

For example, in a small medical facility such as a private practice, a clinic or the like, each of the apparatuses are arranged as shown in FIG. 3.

That is, when entered through an entrance 10, there is a reception 11 for accepting patients and a waiting room 12. A person who is in charge of reception window is disposed at the reception 11, and this person gives a reception number card on which a reception number is printed to the visiting patients for identifying each patient in order of reception, for example. Further, a reception apparatus 4 is provided at the reception 11, and the person who is in charge of reception window asks for the patient's name and inputs the reception number and the patient name in the reception apparatus 4 so as to be associated to each other.

Next to the waiting room 12, an examination room 13 for a doctor to carryout examination, diagnosis and the like of the patient is provided on the other side of a door or the like. For example, on an examination desk (not shown) in the examination room 13, the image management apparatus for medical use 3 (after-mentioned, a server double-used device 3a) to display a taken image of the part targeted for diagnosis of the patient, examination results and the like regarding the examinations carried out to the patient, and the like is disposed for the doctor to carry out diagnosis. Further, in the examination room 13, the ultrasonic diagnostic apparatus 2a in which the examination does not need to be carried out in a separated space in view of privacy and the like is provided.

Moreover, the radiography room 15 for carrying out radiography is provided in the opposite side of the examination room 13 across the hall way 14. In the radiography room 15, the radiography apparatus 22 for taking and image by using a CR cassette and the CR reading apparatus 2d for reading the image from the CR cassette in which an image is recorded are disposed. Furthermore, the laboratory 16 is provided next to the radiography room 15, and the endoscope 2b and the electrocardiogram recording apparatus 2c are disposed in the laboratory 16. Here, although it is not shown, the image management apparatus for medical use 3 (after-mentioned, a referring device 3b) is disposed in each of the radiography room 15 and in the laboratory 16.

Hereinafter, each of the apparatuses structuring the small-scale diagnosis system 1 will be described.

The image generation apparatuses 2 are image generation apparatuses (modalities) which carry out an image taking by setting the part targeted for diagnosis of the patient as the subject image and the image generation apparatuses 2 carry out digital conversion to the taken image to generated image data (taken image information) of the taken image and also, generate image data by recording a predetermined examination results.

As shown in FIG. 1, in the embodiment, the ultrasonic diagnostic apparatus (US) 2a, the endoscope (ES) 2b, the electrocardiogram recording apparatus (ECG) 2c, the CR reading apparatus 2d are included as the image generation apparatuses (modalities) 2. Here, the image generation apparatuses 2 are not limited to these apparatuses, and for example, a computed tomography apparatus (CT: Computed Tomography), a magnetic resonance imaging apparatus (MRI: magnetic resonance imaging) and the like can be provided as the image generation apparatuses 2. Further, a digital camera or the like for taking an image of outside of body such as skin and the like can be provided as the image generation apparatus 2.

Moreover, for example, the structure may be such that a plurality of the same type of image generation apparatuses 2 are provided such as where two CR reading apparatuses 2d are provided or the like. Further, the combination of the image generation apparatuses 2 to be provided in the small-scale diagnosis system 1 is not limited to the exemplified combination.

The ultrasonic diagnostic apparatus 2a includes an ultrasonic probe which outputs ultrasonic wave and an electronic device which converts the sound wave (echo signal) received by the ultrasonic probe to an image data of the taken image of the internal organelle, which is connected to the ultrasonic probe (both are not shown). The ultrasonic diagnostic apparatus 2a transmits ultrasonic wave into the body from the ultrasonic probe and generates a shot image by the electronic device according to the echo signal by receiving the sound wave (echo signal) which is reflected from the inner body organelle again by the ultrasonic probe

To the ultrasonic diagnostic apparatus 2a, a conversion apparatus 21 which is a conversion apparatus (converter) to carry out conversion to digital signal from analog signal and the like, and the ultrasonic diagnostic apparatus 2a is connected to the network 5 via the conversion apparatus 21. By the conversion apparatus 21 intervening as described above, even when data having a form which does not fit the format (for example, communication protocol) of other external devices connected to the network 5 is outputted from the ultrasonic diagnostic apparatus 2a, the data can be arbitrarily converted and sending and receiving of data can be carried out between the external devices connected to the network 5.

In the embodiment, the conversion apparatus 21 includes a function to give UID (unique ID) to image data for specifying the image data in the small-scale diagnosis system 1 in a form according to DICOM format. The UID is structured of identification information (hereinafter, called “modality ID”) of the image generation apparatus 2, a number indicating date and time of image taking and the like. Here, in the embodiment, it is assumed that the modality ID includes information indicating the type of the image generation apparatus 2.

Moreover, the conversion apparatus 21 includes an input section (not shown) such as a key board having a letter input keys, a number input keys and the like. The conversion apparatus 21 double functions as an input device to input patient information for identifying the patient who is targeted for image taking.

Here, patient information broadly includes information for identifying a patient such as patient ID, patient name (kanji, kana, ASCII), gender, date of birth, age and the like of the patient, examination date, time of image taking, reception number, attending physician and the like of the patient. However, the patient information which is inputted in the conversion apparatus 21 are patient ID, patient name, gender and date of birth, for example, among the above. Here, there is no need to input all of the above in the conversion apparatus 21 and it is possible that none of the patient information is inputted. In a case where the conversion apparatus 21 has a mode of inputting only patient ID as the patient information, the input section of the conversion apparatus 21 may be a numerical keyboard or the like, for example.

The UID and the patient information which are given by the conversion apparatus 21 are attached information attached to the image data of the generated shot image.

In the endoscope 2b, a small image taking device is provided at the tip of a tube having flexibility (none of them are shown), and the image taking device includes an objective optical system structured of optical lenses and the like, an imaging section arranged at the image formation position of the objective optical system and a lighting section for carrying out lighting needed for carrying out image taking which is structured of LED (Light Emitting Diode) and the like (all of which are not shown). The imaging section includes a solid-state image sensing device such as CCD (Charge Coupled Device), CMOS (Complementary Metal-Oxide Semiconductor) or the like, for example, and when a light enters, the imaging section carries out opto-electric conversion according to the entered amount of light into an electric signal. The objective optical system is structured so as to collect light in the region lighted by the lighting section by the optical lens and to carry out image formation in the solid-state image sensing device included in the imaging section. Further, the image data of taken image is to be outputted as the electric signal by the opto-electric conversion being carried out to the light entered to the solid-state image sensing device.

The electrocardiogram recording apparatus 2c is an apparatus to obtain and record the wave data by detecting electro cardiac waveform, and the electrocardiogram recording apparatus 2c transmits the generated image data (wave data) to the image management apparatus for medical use 3.

The CR reading apparatus 2d is an apparatus for reading the image data from the CR cassette (not shown) which is the radiographic image conversion medium in which the radiographic image information in which an image of the part targeted for diagnosis is taken.

The CR cassette has a radiographic image conversion plate including a photostimulable phosphor sheet which accumulates radiation energy embedded therein, for example, and at the time of image taking, the CR cassette is to be disposed in the radiation region of the radiation which is irradiated from the radiation source (not shown) of the radiography apparatus 22 (see FIG. 3). When the radiation is irradiated, the CR cassette accumulates radiation in an amount according to the distribution of radiation transmittance at the part targeted for diagnosis in the photostimulable phosphor layer of the photostimulable phosphor sheet, and records the radiographic image information of the part targeted for diagnosis in the photostimulable phosphor layer.

When the CR cassette in which the radiographic image information of the part targeted for diagnosis is recorded is loaded, the CR reading apparatus 2d irradiates excitation light to the photostimulable phosphor sheet within the CR cassette loaded in the apparatus to carry out opto-electric conversion of the photostimulated light which is emitted from the sheet, and generates image data of the taken image by carrying out A/D conversion to the obtained image signal.

Here, the CR reading apparatus 2d may be an integrated apparatus which is integrated with the radiography apparatus 22.

Further, a function to give the above mentioned UID to the generated image data is included in the endoscope 2b, the electrocardiogram recording apparatus 2c and the CR reading apparatus 2d.

Furthermore, the endoscope 2b and the electrocardiogram recording apparatus 2c includes an input section (not shown) such as a key board or the like having letter input keys, number input keys and the like, and the patient information to identify the patient who is targeted for image taking can be inputted.

Here, the patient information which is to be inputted by the input section of each apparatus is not particularly limited, and it is acceptable that none of the patient information is inputted. In a case where the apparatus has a mode in which only patient ID is to be inputted as patient information, the input section may b ae numerical keypad, for example.

The above mentioned UID and patient information are attached information attached to the image data of the taken image which is generated in each of the image generation apparatuses 2.

The image data which is transmitted from the ultrasonic diagnostic apparatus 2a via the conversion apparatus 21 and the image data which is transmitted from the endoscope 2b and the electrocardiogram recoding apparatus 2c are DICOM image data in accordance with DICOM format . In DICOM image data, there is a case where patient information such as patient ID and the like for identifying the patient is attached and there is a case where patient information is not attached. Here, FIG. 2 shows an example of the endoscope 2b.

Further, the image data which is generated by the CR reading apparatus 2d is CRRaW image data (hereinafter, merely called “RAW data”) which is not in accordance with DICOM format, and the image data is transmitted to the image management apparatus for medical use 3 in a state where patient information such as patient ID and the like is not attached.

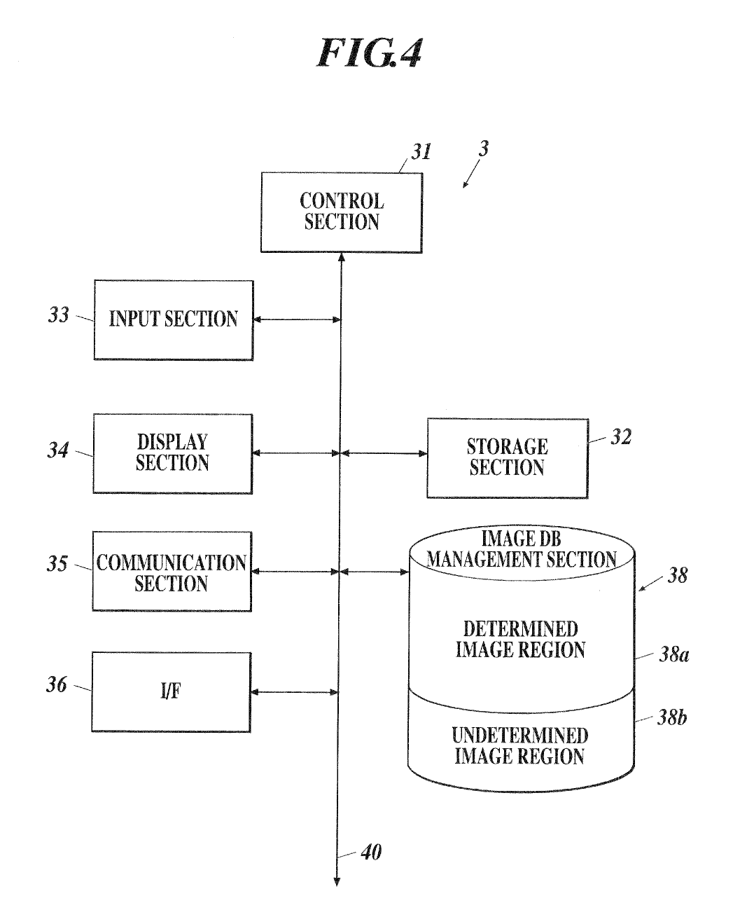

As shown in FIG. 2, the image management apparatus for medical use 3 includes the server double-used device 3a having the image DB management section 38 (see FIG. 4) for storing patient information and image data so as to be associated to each other and the referring device 3b by which the image DB management section 38 of the server double-used device 3a can be referred, which is connected with the server double-used device 3a.

Both of the server double-used device 3a and the referring device 3b are computers including a control section 31, a storage section 32 (see FIG. 4) and the like, and the server double-used device 3a and the referring device 3b are set in the examination room 13 where the doctor carries out examination of a patient, in the laboratory 16 where each of the image generation apparatuses 2 are set, or the like. The server double-used device 3a and the referring device 3b are client apparatuses which can share the data stored in the image DB management section 38 and which can associate image data and patient information to newly write-in to the image DB management section 38 and by which the doctor can carry out reading, diagnosis and the like by displaying an image and the like.

Here, the image management apparatus for medical use 3 may include a monitor which is more high resolution comparing to the monitor (display section) used in a general PC (Personal Computer).

FIG. 4 is a main part block diagram showing a functional structure of the image management apparatus for medical use 3 (server double-used device 3a).

As shown in FIG. 4, the image management apparatus for medical use 3 (server double-used device 3a) includes a control section 31 structured of a CPU (central processing unit) and the like, a storage section 32, an input section 33, a display section 34, a communication section 35, an I/F 36, the image DB management section 38 and the like, and each of the parts are connected by a bus 40. Here, the referring device 3b has a similar structure as the server double-used device 3a shown in FIG. 4 except for the image DB management section 38 is not included.

The storage section 32 includes a ROM (read only memory), a RAM (Random Access Memory) and the like which are not shown.

The ROM is structured of a non-volatile memory such as HDD (Hard Disk Drive) or a semiconductor, for example. In the ROM, image processing parameters (a look-up table in which gradation curve to be used for gradation processing, an enhancement degree of frequency processing and the like) for adjusting the image data of the taken image so as to have image quality suited for diagnosis, and the like in addition to various types of programs.

The RAM forms a work area where temporarily stores various types of programs which can be executed by the control section 31 by being read from the ROM in the various types of processing which are executed and controlled by the control section 31, inputted or outputted data, parameters and the like. In the embodiment, RAM temporarily stores image data received from the image generation apparatuses 2, patient information and the like.

In the embodiment, the storage section 32 functions as a patient information storage device for storing patient information of patients.

The control section 31 is a control device of the image management apparatus for medical use 3 which reads out various types of programs such as a system program, processing program and the like stored in the ROM and expands in the RAM and which executes various types of processing including the after-mentioned patient information association process according to the expanded programs.

The input section 33 includes a key board having letter inputting keys, number inputting keys, various types of function keys and the like, a pointing device such as a mouse, and the input section 33 outputs the pushing signal of the key which is operated by pushing the key board and the operation signal by the mouse as input signal.

For example, the display section 34 includes a monitor such as CRT (Cathode Ray Tube), LCD (Liquid Crystal Display) or the like, and the display section 34 displays various types of screens according to instructions of the display signal which is inputted from the control section 31.

Here, the display section 34 may be a touch screen in which a touch panel (not shown) of pressure sensitive type (resistance film pressure type) in which clear electrodes are arranged in a lattice form on the screen of the display section 34 and in which the display section 34 and the input section 33 are integrally structured. In such case, the touch panel is structured so as to detect XY coordinate of the emphasis where pushed by a finger tip, a touch pen and the like and so as to output the detected position signal to the control section 31 as the operation signal.

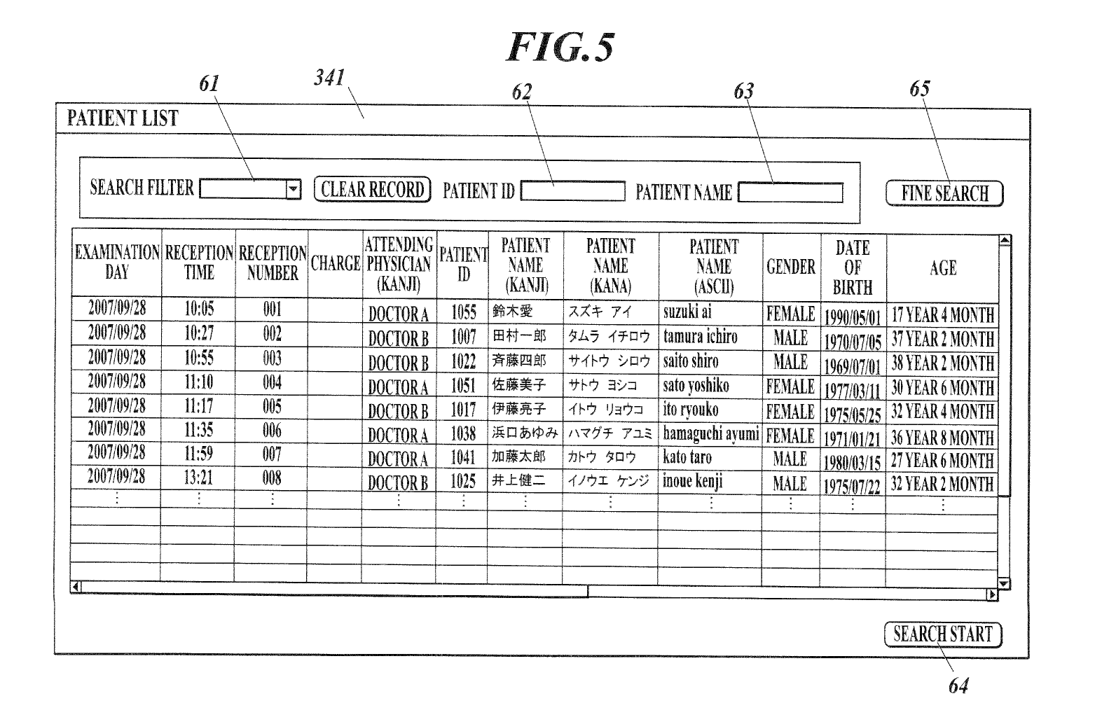

In the embodiment, the display section 34 can display the patient information list screen 341 (see FIG. 5) in which the list (patient information list) of the patient information obtained from the after-mentioned reception apparatus 4. In the patient information list screen 341, a search filter column 61 in which the search filter for searching patient information can be set, a patient ID column 62 for inputting the patient ID of the patient who a user wants to search and a patient name column 63 for inputting the patient name are provided. By a user inputting arbitrary information in each of the columns and by pushing (operating the search start button 64 in the screen by the input section 33 such as the mouse or the like) the search start button 64, the desired patient information can be searched and extracted. Further, when a user wants to carry out a search by inputting more detailed terms, the detailed search terms can be set by pushing the fine search button 65.

As shown in FIG. 5, in the embodiment, patient information such as examination date, reception time, reception number, charge, attending physician, patient ID, patient name (kanji, kana, ASCII), gender, date of birth, age and the like of the visiting patient are displayed as a list. Here, the contents which are to be displayed in the patient information list screen 341 are not limited to the contents exemplified here. The contents to be displayed in the patient information list screen 341 may be a portion of what are exemplified or there may be more items to be displayed.

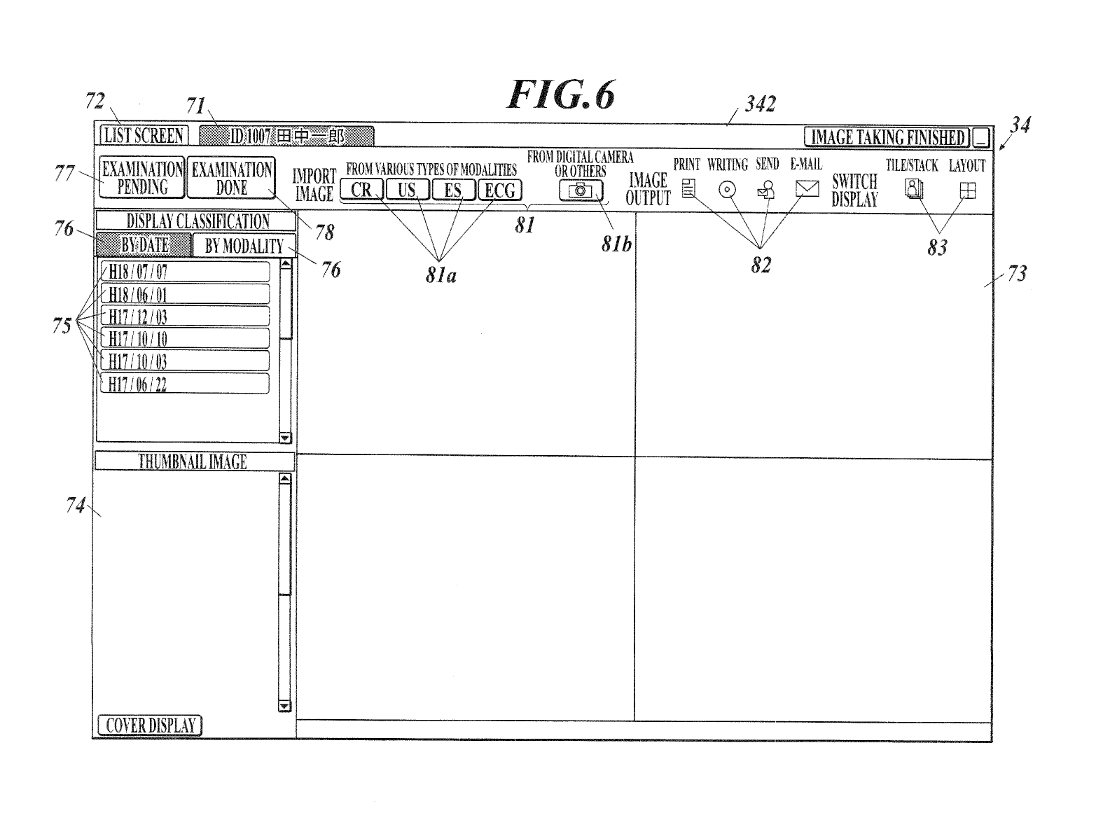

When a patient is selected by selecting (select the column of an arbitrary patient in the screen by the input section 33 such as a mouse) a column of an arbitrary patient among the patients displayed in the patient information list screen 341, the display screen of the display section 34 changes to the patient display screen 342 (see FIG. 6) associated with the selected patient.

In such way, in the embodiment, the patient targeted for diagnosis can be selected from the patient information list screen 341 of the display section 34, and the patient selection device is structured of the patient information list screen 341 and the input section 33.

As shown in FIG. 6, the patient display screen 342 includes the patient display column 71 which displays the patient ID and the patient name of the selected patient, and the patient display screen 342 of which patient is presently being displayed can be visually recognized. Here, when the list screen button 72 is operated, the screen can return to the patient information list screen 341.

In the patient display screen 342, the image display column 73 for displaying an image and the thumbnail display column 74 for displaying the thumbnail of the image are provided.

Further, in the patient display screen 342, the image data selection button 75 for selection image data regarding the patient is provided. By selecting the desired image data by the image data selection button 75, an image based on the image data can be displayed in the image display column 73 and the thumbnail display column 74. The image data selection button 75 can be switched whether to be arranged by either of the two classifications which are according to date or according to image generation apparatus (modality) by the display classification switching button 76.

Moreover, in the patient display screen 342, the examination pending button 77 for inputting that the examination for the image of the patient is put on hold and the examination done button 78 for inputting that the examination is finished are provided.

Furthermore, in the patient display screen 342, the import image button 81 for importing image data from external devices is provided. The import image button 81 is structured of the import image buttons 81a for importing image data from various types of image generation apparatuses 2 which are connected to the network 5 and the import image button 81b for importing image data from various typed of apparatuses such as a digital camera.

In the embodiment, as for the import image buttons 81a, four types of buttons which are “CR”, “US”, “ES” and “ECG” are arranged on the patient display screen 342 so as to be associated with the type (the ultrasonic diagnostic apparatus (US) 2a, endoscope (ES) 2b, the electrocardiogram recoding apparatus (ECG) 2c, the CR reading apparatus 2d) of the image generation apparatuses 2 which are connected to the network 5, respectively.

Here, in a case where other image generation apparatus 2 is connected to the network 5, an import image button 81 so as to be associated with the image generation apparatus 2 is to be provided.

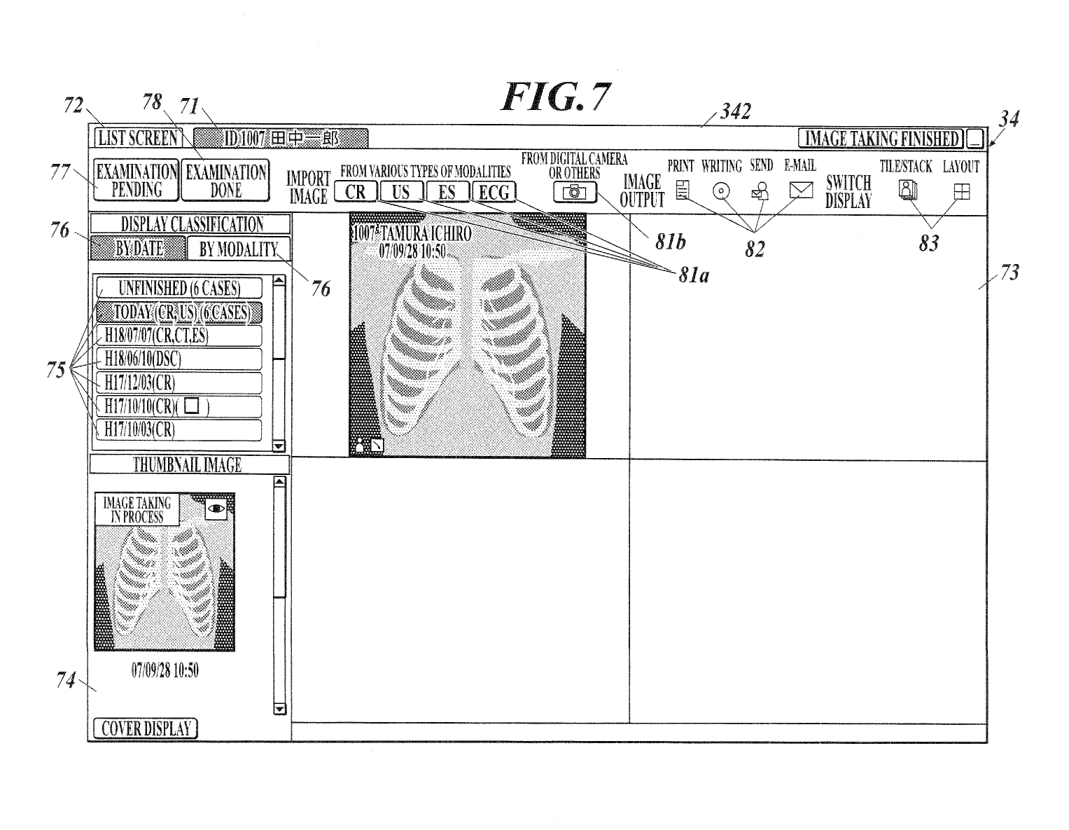

The import image button 81 is for assigning (specifying) the patient to whom the image data generated by the image generation apparatus 2 is to be associated with. When any one of the import image buttons 81 is pushed (operated) in the patient display screen 342, the patient to whom the image data is to be associated with in time of import of the image data is to be assigned (specified) to the patient who is displayed in the patient display screen 342. When the assigning of patient is carried out, the image data which is transmitted to the image management apparatus for medical use 3 from the image generation apparatuses 2 is to be associated with the patient information of the assigned patient. The image data which is associated with the patient information of the patient is stored in the determined image region 38a of the image DB management section 38. Further, an image based on the image data is to be displayed in the image display column 73 of the patient display screen 342 of the patient, and the thumbnail image of the image is to be displayed in the thumbnail display column 74 of the patient display screen 342 of the patient (see FIG. 7).

In such way, in the embodiment, by the import image button 81 being pushed in the patient display screen 342 of the display section 34, the patient to whom the image data is to be associated can be assigned, and the patient assigning devise is structured of the patient display screen 342 and the input section 33.

Further, in the patient display screen 342, the image output button 82 for outputting the imported image by printing, e-mail transmission and the like, the display switching button 83 for switching the display of layout and the like of the image display column, and the like are provided.

The communication section 35 is structured of a network interface and the like, and carries out sending and receiving of data between external devices such as various types of image generation apparatuses 2 which are connected to the network 5 via the switching hub.

In the embodiment, the communication section 35 is the patient information list obtaining device for obtaining the patient information list which is formed (updated) in the after-mentioned reception apparatus 4 from the reception apparatus 4.

The I/F 36 is an interface for connecting the image management apparatuses for medical use 3 and for controlling sending and receiving of data between the image management apparatuses for medical use 3 when there are plurality of image management apparatuses for medical use 3 (for example, in a case where there is one server double-used device 3a and two referring devices 3b as shown in FIG. 2).

The image DB (Data Base) management section 38 is structured of HDD and the like, and is a storage device for storing the image data of the taken image and the patient information so as to be associated with each other.

As shown in FIG. 4, the image DB management section 38 includes the determined image region 38a for storing image data of the determined image which is associated with the patient information of the patient and the undetermined image region 38b for storing image data of undetermined image which is not associated with the patient information of the patient.

Here, the patient information association process by the control section 31 will be described.

When image data is transmitted from the image generation apparatus 2, the control section 31 determines whether patient ID which is patient information is attached to the image data or not. When the patient ID is attached, the control section 31 checks the attached patient ID and other patient information to the patient information such as patient ID and the like stored in the storage section 32 in the image management apparatus for medical use 3 side. Thereafter, when there is a patient to whom the patient information matches in the storage section 32, the control section 31 associates the image data to the patient and when there is no patient to whom the patient information matches, the control section 31 determines the image data as an undetermined image.

On the other hand, when patient ID is not attached to the image data, the control section 31 determines whether the import image button 81 is pushed in either of the client devices (the server double-used device 3a or the referring device 3d) of not. When the import image button 81 is pushed, the image is imported to the client device in which the import image button 81 is pushed. When the import image button 81 is not pushed, the image data is determined as an undetermined image.

When the image data is determined as an determined image, the control section 31 automatically carries out associating of the image data and patient information of a patient according to the predetermined allocation rule.

In the embodiment, a description will be given for a case where an allocation rule of associating image data with the patient information of the patient who is selected by the client device (that is, the patient display screen 342 is displayed) when a specific client device (the server double-used device 3a or the referring device 3b) is set by default as a destination to allocate the image data in advance and an allocation rule of associating image data with the patient information of the specific patient when a specific patient is set by default as a destination to allocate the image data are set in advance.

In such case, the control section 31 determines whether a specific client device (the server double-used device 3a or the referring device 3b) is set by default as the destination to allocate the image data or not. When either one of the client devices is set as default and when any one of patients is selected by the client device and the patient display screen 342 of the patient is displayed, the control section 31 associates the patient information of the patient who is displayed in the patient display screen 342 with the image data.

When there is no client device which is set as default or when the patient display screen 342 is not displayed in the client device which is set as default, the control section 31 further determines whether there is a patient who is set as default or not. Further, when any one of patients is set as default, the control section 31 associates the image data with the patient information of the patient.

When the image data and the patient information are associated, the control section 31 stores the image data in a state where the image data is associated with the patient information such as the patient ID and the like in the determined image region 38a of the image DB management section 38.

Here, when the image data and the patient information are automatically associated by the allocation rule, the control section 31 displays an indication notifying that the associating was carried out according to the allocation rule in the display section 34 when displaying the taken image based on the image data in the display section 34.

The reception apparatus 4 is a computer apparatus for carrying out reception registration of visiting patient, calculation of payment, calculation of insurance points and the like. The reception apparatus 4 includes a CPU, a storage section structured of a ROM, a RAM and the like, an input section structured of a key board, a mouse and the like, a display section structured of CRT, LCD or the like, a communication section for controlling communication between each of the apparatuses connected to the network 5 and the like (all of which are not shown). When displaying of a reception input screen is instructed by the input section, the reception apparatus 4 displays the reception input screen which is not shown in the display section by the software process by the CPU and the program stored in the storage section cooperating with each other. When reception information (reception number+patient name) is inputted by the input section via the reception input screen, the patient information list of the accepted patient is formed (updated) and stored in the storage section and is arbitrarily transmitted to the image management apparatus for medical use 3 by the communication section.

Next, a flow of examination of one patient in a small facility in which the small-scale diagnosis system 1 is applied will be described.

When a patient visits a medical facility, a reception number card is given to the patient at the reception 11, and the reception number of the patient who was accepted and various types of patient information that structure the patient information list such as patient name and the like are inputted (reception input) by the operation of the input section in the reception apparatus 4. In the reception apparatus 4, when the reception number of the patient and the patient information and the like are inputted, the list of the patient information (patient information list) is generated (updated) and stored in a predetermined region of the RAM. For example, the patient information list is generated when reception input is carried out for the first patient of the day and is stored in a predetermined region of the RAM, and the patient information list is updated to a new patient information list every time the reception input is carried out for the next patient.

When the patient to whom the reception number is given moves to the examination room 13, questioning is carried out by the doctor and image taking and examination which should be carried out are determined.

When it is decided that image taking of the affected area is necessary from the questioning, the person who carries out the image taking such as an imaging technician, a nurse or the like takes the patient in front of the image generation apparatus 2 (the ultrasonic diagnostic apparatus 2a, the endoscope 2b, the electrocardiogram recording apparatus 2c or the CR reading apparatus 2d) by which the image taking is carried out, carries out image taking by setting the part targeted for diagnosis of the patient as subject and generates image data of the taken image. For example, when the image generation apparatus 2 is the CR reading apparatus 2d, image taking is carried out by the radiography apparatus 22, and sets the CR cassette in which image taking is already carried out in the radiography apparatus 22 in the CR reading apparatus 2d to carryout reading of the radiographic image recorded in the CR cassette. When the image taking and generation of image data are carried out according to the operation of the person who carries out the image taking in the image generation apparatus 2, the above mentioned UID is given to the generated image data. Further, in case of an apparatus according to DICOM format such as the endoscope 2b or and the like and when the patient information is inputted, UID and the patient information are given to the generated image data.

The image data generated in each of the image generation apparatuses 2 is transmitted to the image management apparatus for medical use 3 along with attached information such as UID and patient information.

When the image data is transmitted to the image management apparatus for medical use 3 from the image generation apparatus 2, the control section 31 of the image management apparatus for medical use 3 carries out the patient information association process to associate the image data with the patient information of the patient stored in the storage section 32. In the embodiment, the image management apparatus for medical use 3 be in a state capable of displaying, reading and diagnosing the shot image which is based on the image data in the patient display screen 342 (FIG. 7) of the patient by the image data being associated with any on the patients.

When the association of the image data and the patient is carried out and when the state becomes such that the image data can be displayed in the patient display screen 342, the doctor displays the taken image and the like received from the image generation apparatus 2 in the display section 34 of the image management apparatus for medical use 3 and refers to the taken image to carry out reading and diagnosis of the patient.

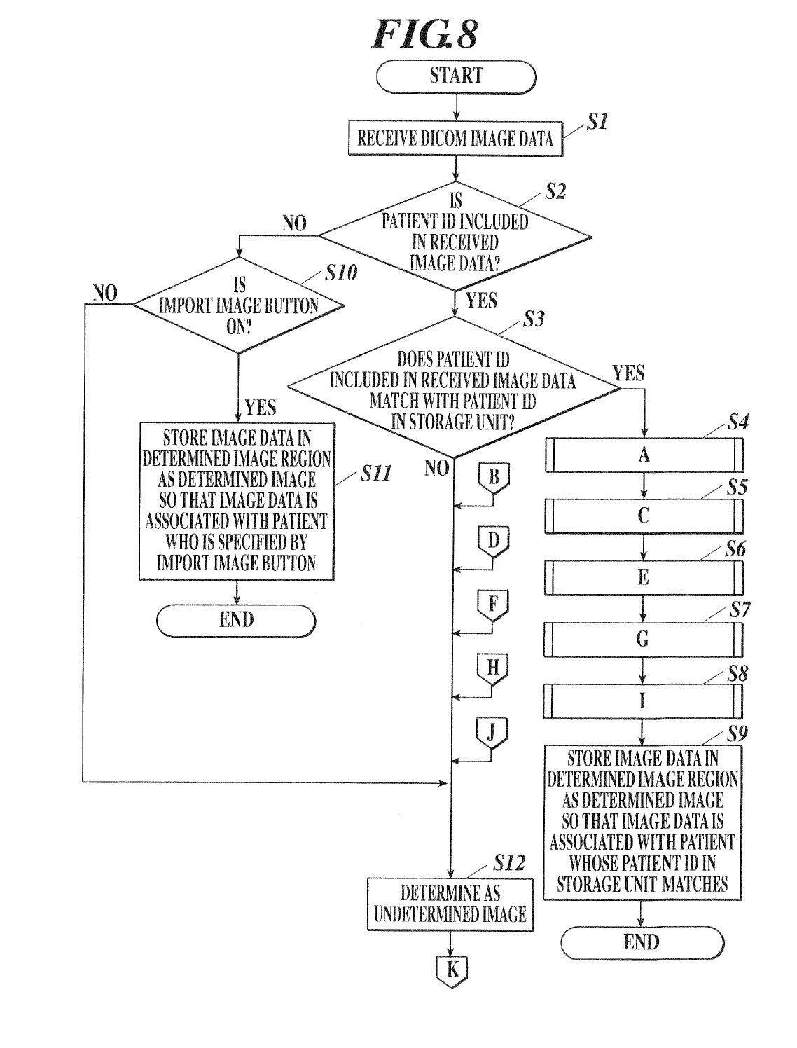

Here, the patient information association process of the embodiment will be described with reference to FIGS. 8 to 14.

As shown in FIG. 8, when the control section 31 receives image data (step S1), the control section 31 determines whether a patient ID as patient information is attached to the image data or not (step S2). When a patient ID is attached to the image data (step S2: YES), the control section 31 determines whether there is patient information that matches to the patient ID attached to the image data among the patient information of the patients stored in the storage section 32 or not (step S3).

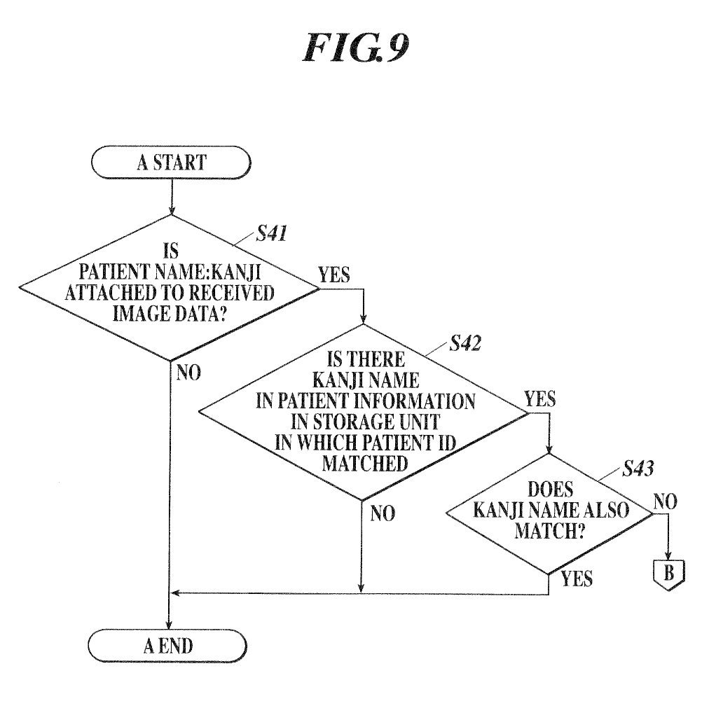

When the patient ID matches to any one of patient IDs of the patients stored in the storage section 32 (step S3, YES), the control section 31 determines whether a patient name (kanji: hereinafter called “kanji name”) is attached to the image data or not (step S41) as shown in FIG. 9. When a kanji name is attached to the image data (step S41: YES), the control section 31 further determines whether a kanji name is included in the patient information in the storage section 32 in which the patient ID matched or not (step S42). When a kanji name is included in the relevant patient information (step S42: YES), with regards to the kanji name, the control section 31 also determines whether the kanji name matches to the kanji name attached to the image data or not (step S43). When the kanji name attached to the image data and the kanji name included in the patient information in the storage section 32 do not match (step S43: NO), the control section 31 determined the image data as an undetermined image (step S12).

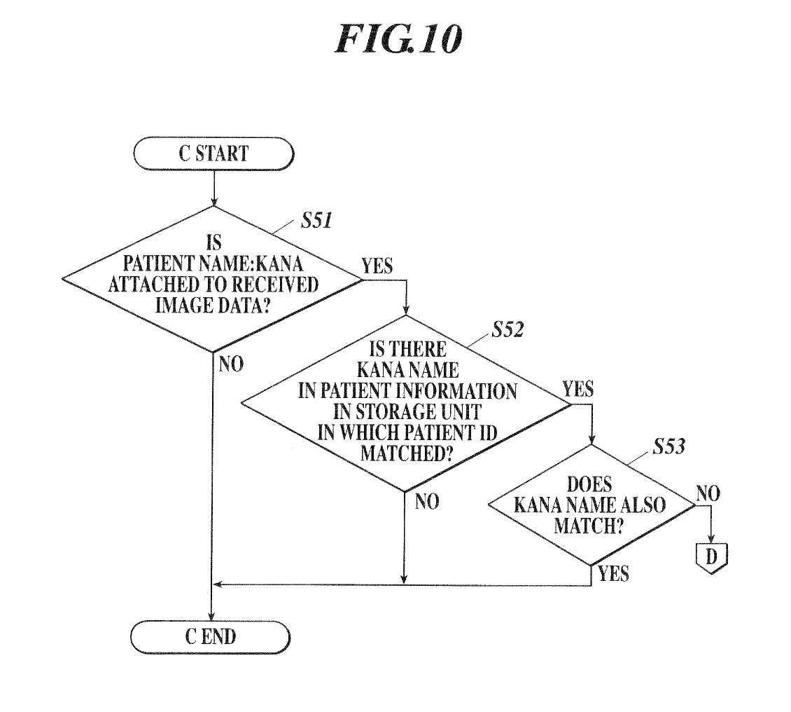

When a kanji name is not attached to the image data (step S41: NO), the control section 31 determines whether a patient name (kana: hereinafter called “kana name”) is attached to the image data or not (step S51) as shown in FIG. 10 when a kanji name is attached but a kanji name is not included in the relevant patient information in the storage section 32 (step S42: NO) and when the kanji name attached to the image data and the kanji name included in the patient information in the storage section 32 match (step S43: YES). When a kana name is attached to the image data (step S51: YES), the control section 31 further determines whether a kana name is included in the patient information in the storage section 32 in which the patient ID matched (step S52). When a kana name is included in the relevant patient information (step S52: YES), regarding the kana name, the control section 31 also determines whether the kana name matches the kana name attached to the image data or not (step S53). When the kana name attached to the image data and the kana name included in the patient information in the storage section 32 do not match (step S53: NO), the control section 31 determines the image data as an undetermined image (step S12).

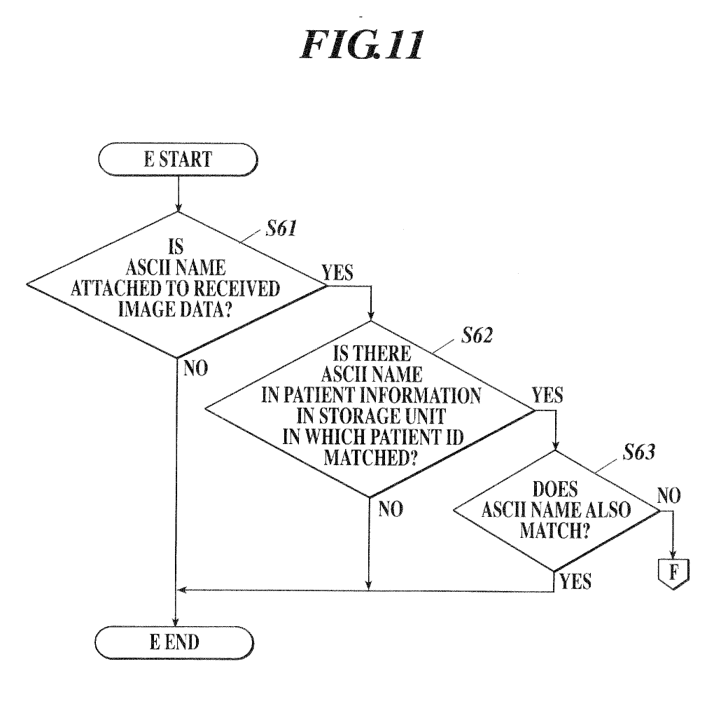

When a kana name is not attached to the image data (step S51: NO), the control section 31 determines whether a patient name (ASCII: hereinafter called “ASCII name”) is attached to the image data or not (step S61) as shown in FIG. 11 when the kana name is attached but a kana name is not included in the relevant patient information in the storage section 32 (step S52: NO) and when the kana name attached to the image data and the kana name included in the patient information in the storage section 32 match (step S53: YES). When an ASCII name is attached to the image data (step S61: YES), the control section 31 further determines whether an ASCII name is included in the patient information in the storage section 32 in which the patient ID matched or not (step S62). When an ASCII name is included in the relevant patient information (step S 62: YES), with regards to the ASCII name, the control section 31 also determines whether the ASCII name matches to the ASCII name attached to the image data or not (step S63). When the ASCII name attached to the image data and the ASCII name included in the patient information in the storage section 32 do not match (step S63: NO), the control section 31 determines the image data as an undetermined image (step S12).

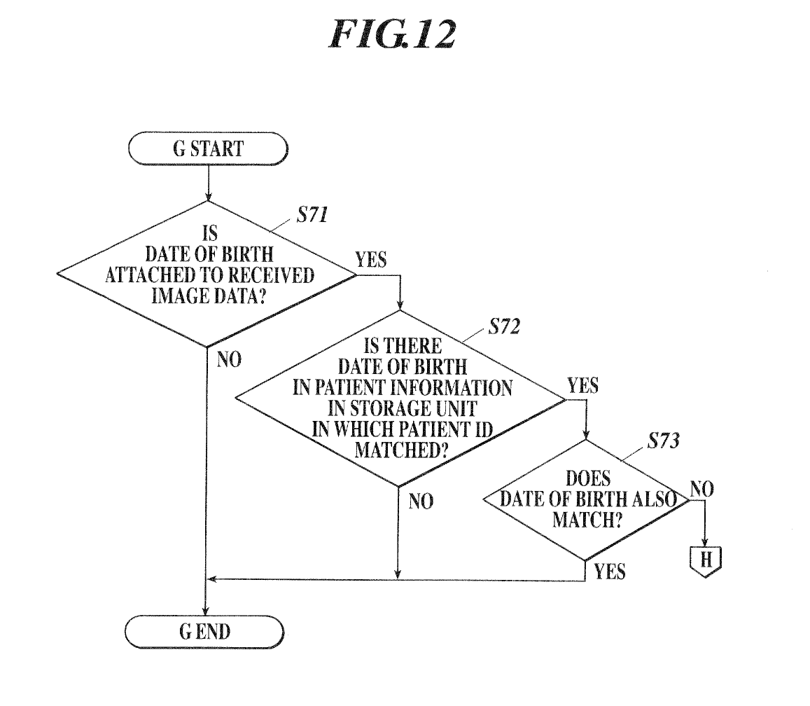

When an ASCII name is not attached to the image data (step S61: NO), the control section 31 determines whether date of birth information (hereinafter, merely called “date of birth”) is attached to the image data or not (step S71) as shown in FIG. 12 when the ASCII name is attached but an ASCII name is not included in the relevant patient information in the storage section 32 (step S62: NO) and when the ASCII name attached to the image data and the ASCII name included in the patient information in the storage section 32 match (step S63: YES). When date of birth is attached to the image data (step S71: YES), the control section 31 further determines whether date of birth is included in the patient information in the storage section 32 in which the patient ID matched (step S72). When date of birth is included in the relevant patient information (step S72: YES), with regards to the date of birth, the control section 31 also determines whether the date of birth matches the date of birth attached to the image data or not (step S73). When the date of birth attached to the image data and the date of birth included in the patient information in the storage section 32 do not match (step S73: NO), the control section 31 determines the image data as an undetermined image (step S12).

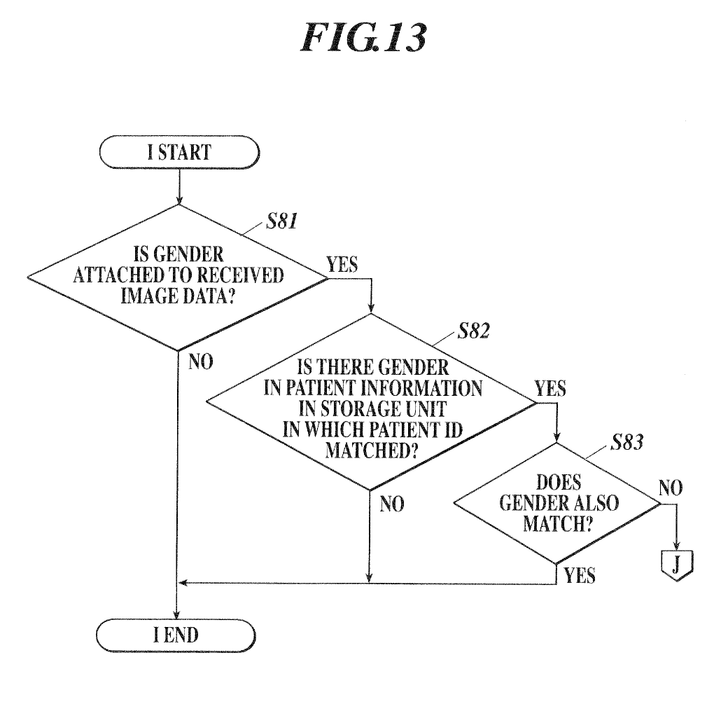

When date of birth is not attached to the image data (step S71: NO), the control section 31 determines whether gender information (hereinafter, merely called “gender”) is attached to the image data or not (step S81) as shown in FIG. 13 when date of birth is attached but date of birth is not included in the relevant patient information in the storage section (step S72: NO) and when the date of birth attached to the image data and the date of birth included in the patient information in the storage section match (step S73: YES). When gender is attached to the image data (step S81: YES), the control section 31 further determines whether gender is included in the patient information in the storage section 32 in which the patient ID matched (step S82). When gender is included in the relevant patient information (step S82: YES), with regard to the gender, the control section 31 also determines whether the gender matches the gender attached to the image data or not (step S83). When the gender attached to the image data and the gender included in the patient information in the storage section 32 do not match (step S83: NO), the control section 31 determines the image data as an undetermined image (step S12).

Moreover, when the gender attached to the image data and the gender included in the patient information in the storage section 32 match (step S83: YES), the control section 31 stores the image data in the determined image region 38a of the image DB management section 38 as a determined image by associating the image data with the patient in the storage section 32 in which the patient ID matched (step S9).

On the other hand, When patient ID is not attached to the image data (step S2: NO), the control section 31 determines whether the import image button 81 is pushed in either of the client devices including the server double-used device 3a and the referring device 3b or not (step S10) as shown in FIG. 8. When the import image button 81 is pushed in either one of the client devices (step S10: YES), the image data is associated with the patient information of the patient specified by the import image button 81 to be stored in the determined image region 38a of the image DB management section 38 as a determined image (step S11).

On the other hand, when the import image button 81 is not pushed in either of the client devices (step S10: NO), the control section 31 determines the image data as an undetermined image (step S12).

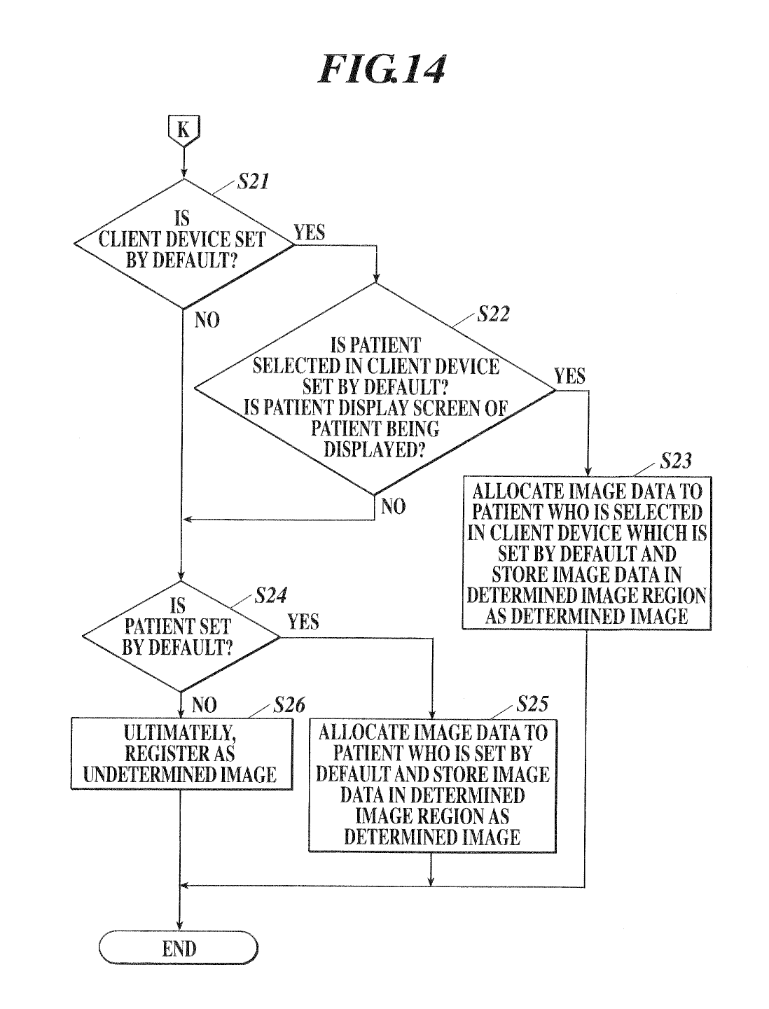

When the image data is determined as an undetermined image, the control section 31 determines whether a specific client device (the server double-used device 3a or the referring device 3b) is set as default as the destination to allocate the image data or not (step S21) as shown in FIG. 14. When either one of the client devices is set as default (step S21: YES), the control section 31 further determines whether a patient is selected in the client device which is set as default, that is, whether a patient display screen 342 of any of patients is displayed in the display section 34 or not (step S22). When a patient is selected in the client device (step S22: YES), the control section 31 allocates the image data to the selected patient, and the control section 31 associates the patient information of the patient and the image data and attaches information of the allocation rule used for the association to store the image data in the determined image region 38a of the image DB management section 38 as a determined image (step S23).

When there is not client device set as default (step S21: NO) or when a patient is not selected by the client device which is set as default (step S22: NO), the control section 31 determines whether a patient is set as default or not (step S24). When a patient is set as default (step S24: YES), the control section 31 allocates the image data to the patient, and the control section 31 associates the patient information of the patient and the image data and attaches information of the allocation rule used for the association to store the image data in the determined image region 38a of the image DB management section 38 as the determined image (step S25).

When the image data and the patient information are automatically associated by the allocation rule, the control section 31 displays an indication notifying that the association is carried out according to the allocation rule in the display section 34 when displaying the taken image based on the image data in the display section 34.

On the other hand, when there is no patient set as default (step S24: NO), the control section 31 ultimately determines the image data as an determined image and stores the image data in the undetermined image region 38b of the image DB management section 38.

As described above, according to the embodiment, the image data can be made to be associated with the patient information of the assigned patient when the patient to whom the image data is to be associated is assigned even when CRRaw image data to which patient information is not attached is transmitted from the CR reading apparatus 2d or when DICOM image data to which patient information is not attached is transmitted from various types of image generation apparatuses 2 according to DICOM format. Further, association of the image data and patient information of a patient can be carried out automatically according to a predetermined allocation rule even when the patient to whom the image data is to be associated is not assigned. Therefore, the image management apparatus for medical use 3 effectively carries out the association of the image data and patient information and can make the taken image be in a state where the taken image can be read and can be used for diagnosis even when it is structured that the taken image cannot be displayed in the display section 34 unless the image data is associated with any one of the patients.

Further, in most cases the patient selected by the client device (the server double-used device 3a or the referring device 3b) when receiving the image data is the patient who a user of the client device intends as the patient to whom the image data is to be associated. In view of this aspect, in the embodiment, when there is a client device which is set as default in advance, the image data is associated to the patient information of the patient selected by the client device. Therefore, for example, when the patient is not assigned due to a user forgetting to push the import image button 81 or the like even when a user desires to associated the image data to the patient, the association in complying with a user's intention can be carried out properly.

Moreover, when a specific client device is not set as default, the image data is associated with the patient information of a predetermined specific patient. Therefore, an operation according to the circumstances of the facility can be carried out such that setting the patient as default so as to associate the image data when the patient to whom the image data is to be associated with is clear even when the patient is not assigned, in such case where the patients to whom image taking needs to be carried out is limited due to the number of patients being small, for example.

Further, as described above, even when the taken image cannot be displayed in the display section 34 unless the image data is associated with any one of the patients, the image management apparatus for medical use 3 can tentatively set so as to be in a state where the taken image can be displayed. Therefore, it is convenient to carry out reading and diagnosis.

Furthermore, in the embodiment, when the association of the image data and the patient information is automatically carried out according to the allocation rule, an indication notifying that the associating was carried out according to the allocation rule is displayed in the display section 34. Therefore, a user can be notified that the association of the image data and the patient information is not according to matching of patient ID and the like and that there may be error, and a user can be alerted when carrying out reading, diagnosis and the like.

Here, in the embodiment, when a patient ID is attached to the image data but could not ultimately be associated with any of the patients, the image data is determined as an undetermined image (step S12 of FIG. 8) and the association of the image data and patient information is carried out automatically according to the allocation rule. However, when the association could not be carried out even though patient ID is attached, the automatic association may not be carried out and the image data may be stored in the undetermined image region of the image DB management section 38 as an undetermined image.

Associating the image data with patient information of a patient who has different patient ID despite a patient ID is attached to the image data leads to a great danger of mixing-up the image data and the patient and causes misdiagnosis. Therefore, there are cases where it is preferable that such image data is to be stored as an undetermined image and then a user carry out association of the image data and patient information manually while confirming each one of the image data.

Further, in the embodiment, first, it is determined whether a patient ID is attached to the image data or not and when a patient ID is attached to the image data, it is required to determine whether the patient ID and patient information of patients stored in the storage section 32 match or not. However, the patient information association process is not limited to this. For example, when the import image button 81 of either of the client device is pushed, the image data may be associated with the patient information of the patient who is selected/assigned by the client device without determining whether a patient ID is attached or not.

By having the above described structure, when there are number of image taking using the CR cassette to be carried out or when there are many cases where image data is transmitted without patient ID being attached even when the image generation apparatus 2 according to DICOM format is used, process can be simplified according to circumstances of the facility such that the number of client devices is small and that there is very small possibility for erroneously associating image data and patient information even when the patient ID is not confirmed each time.

Furthermore, in the embodiment, when a specific client device is set as default, the image data is associated with the patient information of the patient who is selected by the client device. However, when a patient is selected by either one of the client devices, the image data may be associated with the patient information of the selected patient even when there is no such default setting. For example, when the number of client devices is small and when it is under a usage situation where a condition in which a plurality of patients are selected at the same time by a plurality of client devices does not occur, there is no possibility of mixing-up image data and patient information even when having a structure as described above, and an efficient patient information association process can be carried out.

Moreover, the allocation rule used when carrying out the patient information association process is not limited to what is described in the embodiment. For example, an allocation rule of association the image data with patient information according to the type of the image generation apparatus 2 which generated the image data can be set. In such case, the control section 31 identifies the type of the image generation apparatus 2 which generated the image data based on the modality ID included in the UID attached to the image data.

For example, when there is only one patient to whom image taking by the ultrasonic diagnostic apparatus 2a is to be carried out in the facility, the image data which is generated by the ultrasonic diagnostic apparatus 2a is to be associated with the patient information of the patient for sure. In a small facility where the number of patients is small, association of image data and patient information can be carried out more efficiently by setting an allocation rule having the above described rule.

Further, in the embodiment, when the association of the image data and patient information is automatically carried out according to an allocation rule, an indication for notifying that the association is carries out according to the allocation rule is made to be displayed in the display section 34. However, for example, a user can be notified that the association was carried out automatically with a notification by lighting of a lamp or by a sound.

Here, in the embodiment, a case where an input device for inputting patient information is not provided in the CR reading apparatus 2d is exemplified. However, an input device for inputting patient information may be also provided in the CR reading apparatus 2d.

Further, in the embodiment, the image data to which patient information is associated is stored in the image DB of the image management apparatus for medical use 3. However, the storage device for storing image data is not limited to this. For example, image data may be stored in an external storage device or in detachable storage device.

Furthermore, in the embodiment, the patient selection device is structured of the patient information list screen 341 and the input section 33 and the description is given for a case where the screen is changed to the patient display screen 342 by selecting an arbitrary patient in a list displayed in the patient information list screen 341. However, the patient selection device is not limited to this.

For example, the screen may be made to be changed to the patient display screen of the patient by displaying a patient search screen (not shown) which includes an information input column for inputting information which becomes a key for search and by inputting patient ID, patient name in the information input column from the input section 33 to carry out search. In such case, the patient selection device is structured of the patient search screen and the input section 33.

Moreover, in the embodiment, a structure in which two referring devices 3b are connected to a server double-used device 3a is exemplified as the image management apparatus for medical use 3. However, the structure of the image management apparatus for medical use 3 is not limited to this. For example, the image management apparatus for medical use 3 may be structured of only the server double-used device 3a or may be structured of three or more referring devices 3b.

Further, the arrangement of the server double-used device 3a and the referring devices 3b is not limited that the arrangement shown in FIG. 3. For example, one referring device 3b among the referring devices 3b may be set in the reception 11. In such case, the referring devices 3b and 3c may be double used as the reception apparatus 4. Furthermore, the image management apparatus for medical use 3 may be set so as to correspond to each image generation apparatus 2.

In addition, it is needless to say that the present invention is not limited to the above described embodiment and can be arbitrarily changed.

### INDUSTRIAL APPLICABILITY

The image management apparatus for medical use can be applied in a field of carrying out a management of medical images.

### DESCRIPTION OF MARKS

1 small scale diagnosis system

2 image generation apparatus

2a ultrasonic diagnostic apparatus

2b endoscope

2c electrocardiogram recording apparatus

2d CR reading apparatus

3 image management apparatus for medical use

3a server double-used device

3b referring device

4 reception apparatus

5 network

21 conversion apparatus

22 radiography apparatus

31 control section

32 storage section

33 input section

34 display section

341 patient information list screen

342 patient display screen

35 communication section

36 I/F

38 image DB

38a determined image region

38b undetermined image region

40 bus

1. An image management apparatus for medical use which is connected to an image generation apparatus for generating image data relating to a patient so as to carry out sending and receiving of data, comprising:
a patient information storage section for storing patient information of patients who are to be examined;
a patient selection section for selecting a patient who is to be a target for examination among the patients stored in the patient information storage section;
a patient specification section for specifying the patient selected by the patient selection section as a patient to whom the image data is to be associated with; and
a control unit for associating the image data transmitted from the image generation apparatus with patient information of the patient who is specified when the patient is specified by the patient specification section, and for automatically associating the image data with patient information of a patient according to a predetermined allocation rule when the patient is not specified by the patient specification section.

2. The image management apparatus for medical use of claim 1, wherein the control unit associates the image data with the patient information of the patient, according to an allocation rule of associating the image data with the patient information of the patient selected by the patient selection section when receiving the image data.

3. The image management apparatus for medical use of claim 1, wherein the control unit associates the image data with the patient information of the patient, according to an allocation rule of associating the image data with patient information according to a type of the image generation apparatus which generated the image data.

4. The image management apparatus for medical use of claim 1, wherein the control unit associates the image data with the patient information of the patient, according to an allocation rule of associating the image data with patient information of a patient who is specified in advance.

5. The image management apparatus for medical use of claim 1, further comprising a display section,
wherein when an association of the image data and the patient information is carried out automatically according to an allocation rule, the control unit controls the display section to display an indication notifying that the association is carried out according to the allocation rule.
